(19) United States
(12) Patent Application Publication
(10) Pub. No.: US 2008/0115880 A1
(43) Pub. Date: May 22, 2008

(54) Manufacturing process of the combining of optical lens and sensor chips

(75) Inventor: Chao-chi Chang, Taipei City (TW)

Correspondence Address: BRUCE H. TROXELL, SUITE 1404, 5205 LESSBURG PIKE, FALLS CHURCH, VA, 22041, US

(73) Assignee: ETHER PRECISION, INC.

(21) Appl. No.: 11/640,249

(22) Filed: Dec. 18, 2006

(30) Foreign Application Priority Data
Nov. 16, 2006 (TW) 95142246

(51) Int. Cl. B32B 38/00

(52) U.S. Cl. 156/250

(57) ABSTRACT

A manufacturing process of the combining of optical lens and senor chips includes the steps of: preparation of a wafer with a plurality of image sensor chips thereon, connection of a plurality of optical lens assemblies to the wafer, wherein each of the optical lens assemblies is associated with the image sensor chip respectively, and division of the wafer to have a plurality of image catch units.

### BACKGROUND OF THE INVENTION

1. Field of the Invention

The present invention relates generally to an optical lens assembly, and more particularly to a manufacturing process of the combining of optical lens and senor chips.

2. Description of the Related Art

As shown in FIG. 1, a conventional image catch unit 1 includes an optical lens assembly 2 and an image sensor 3 in front of the image sensor 3. The optical lens assembly 2 includes lenses 4, a barrel 5 and a holder 6. The optical lens assembly 2 is attached on the image sensor 3 by adhesive in a range of a depth of focus of the image sensor 3. Conventional package processes of the image sensor includes chip on board (COB), tape carrier package (TCP), which is the most common process, and chip on glass (COG). These processes have advantages of simple process and lower cost, but they still have some parts for improvement.

In addition, a conventional process of combination of the optical lens assembly and the image sensor is to attach the lenses on the packaged image sensor that is a hard and long time work.

### SUMMARY OF THE INVENTION

The primary objective of the present invention is to provide a manufacturing process of the combining of optical lens and senor chips, which has no drawback above and good for mass production of image catch unit. The method of the present invention has advantage of simple process and lower cost.

The secondary objective of the present invention is to provide a manufacturing process of the combining of optical lens and senor chips, which keeps clean of the image catch units and decreases the ratio of defective.

According to the objectives of the present invention, a manufacturing process of the combining of optical lens and senor chips includes the steps of: preparation of a wafer with a plurality of image sensor chips thereon, connection of a plurality of optical lens assemblies to the wafer, and division of the wafer to have a plurality of image catch units.

### BRIEF DESCRIPTION OF THE DRAWINGS

FIG. 1 is a sectional view of the conventional image catch unit;

FIG. 2 is a flow chart of a preferred embodiment of the present invention;

FIG. 3 is a top view of the wafer of image sensor chips;

FIG. 4 is a perspective view of the image catch unit; and

FIG. 5 is a perspective view of the optical lens assemblies on the wafer.

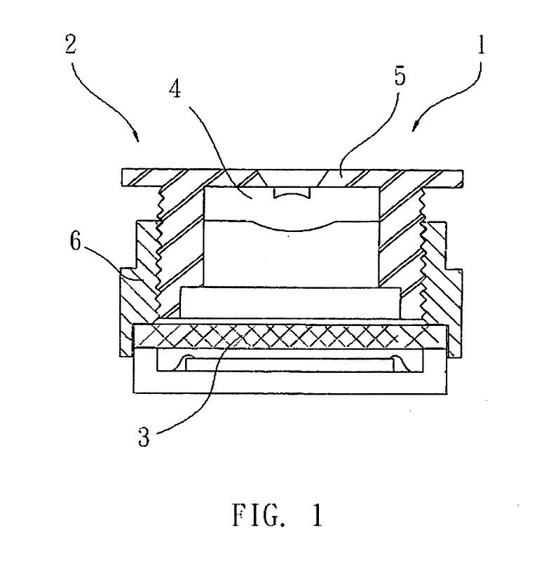

### DETAILED DESCRIPTION OF THE INVENTION

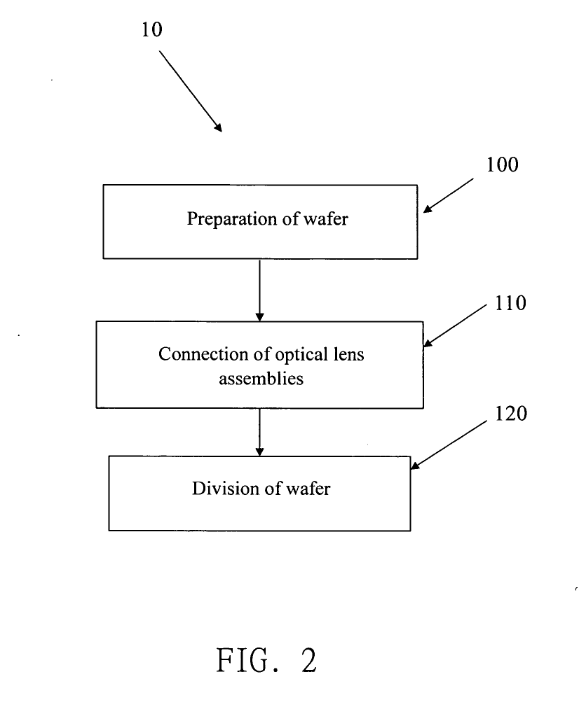

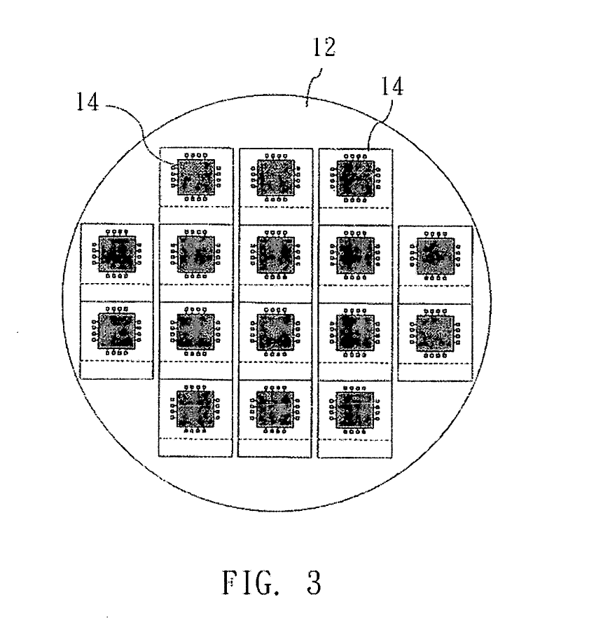

As shown in FIG. 2 to FIG. 4, a manufacturing process 10 of the combining of optical lens and senor chips includes:

Preparation of a wafer 100: the wafer 12 includes a plurality of image sensor chips 14 thereon, each of which is a silicon chip.

Connection of optical lens assemblies 110: attaching the optical lens assemblies 16 on the image sensor chips 14 respectively by a specific machine to form a plurality of image catch units 18 on the wafer 12. Each of the optical lens assemblies 16 is made by making a barrel by lithography electroforming micro molding (LIGA) or deep reactive ion etching (DRIE) and assembling lenses onto the barrel.

Division of the wafer 120: a cutter is used to divide the wafer 12 to have a plurality of independent image catch units 18.

The manufacturing process of the present invention provides the pre-cut wafer 12 with the image sensor chips 14 thereon and attached with the optical lens assemblies 16 associated with each image sensor chip 14, and then the wafer 12 is cut to get a plurality of the image catch units 18 once. The method of the present invention may simplify the fabrication process and lower the cost of fabrication, furthermore, it reduces the risk of pollution of the image sensor chips in fabrication and decreases a ratio of defective.

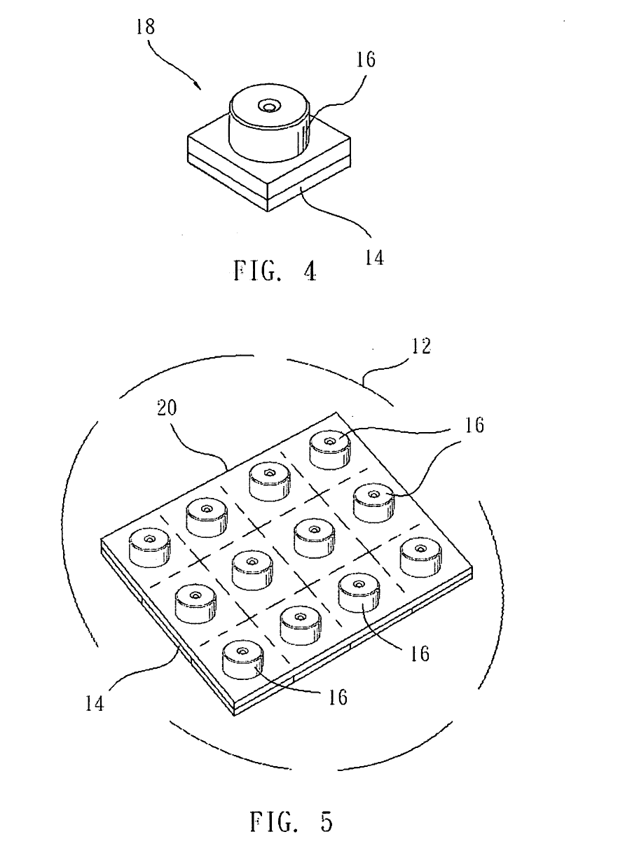

In addition, the present invention also may provide an array 20 of the optical lens assemblies 16, as shown in FIG. 5, attached on the wafer 12 of the image sensor chips 14. The array 20 is made by making barrels by lithogrophy electroforming micro molding (LIGA) or deep reactive ion etching (DRIE) and assembling lenses onto the barrels respectively. The cutting process cuts both of the wafer 12 and the array 20 to get a plurality of the image catch units 18 once.

In conclusion, the manufacturing process of the present invention provides the pre-cut wafer attached with the optical lens assemblies, and then the wafer is cut to get a plurality of the image catch units once. The method of the present invention may simplify the fabrication process and lower the cost of fabrication, furthermore, it reduces the risk of pollution of the image sensor chips in fabrication and decreases a ratio of defective.

The description above is a few preferred embodiments of the present invention and the equivalence of the present invention is still in the scope of the claim of the present invention.

What is claimed is:

1. A manufacturing process of the combining of optical lens and senor chips, comprising the steps of:
preparing a wafer with a plurality of image sensor chips thereon;
connecting a plurality of optical lens assemblies to the wafer, wherein each of the optical lens assemblies is associated with the image sensor chips respectively;
dividing the wafer to have a plurality of image catch units, wherein each of the image catch units includes one image sensor chip and one optical lens assembly.

2. The manufacturing process as defined in claim 1, wherein the wafer is divided by a cutter.

3. The manufacturing process as defined in claim 2, wherein the optical lens assemblies are attached on the wafer by an adhesive.

4. The manufacturing process as defined in claim 1, wherein the optical lens assemblies are attached on the wafer in the same time.

5. The manufacturing process as defined in claim 4, wherein each of the optical lens assembly is made by making a barrel by lithogrophy electroforming micro molding (LIGA) and assembling at least a lens onto the barrel.

6. The manufacturing process as defined in claim 4, wherein each of the optical lens assembly is made by making a barrel by deep reactive ion etching (DRIE) and assembling at least a lens onto the barrel.

7. A manufacturing process of the combining of optical lens and senor chips, comprising the steps of:
preparing a wafer with a plurality of image sensor chips thereon;
connecting an array with a plurality of optical lens assemblies to the wafer, wherein each of the optical lens assemblies of the array is associated with the image sensor chips of the wafer respectively;
dividing the wafer and the array to have a plurality of image catch units, wherein each of the image catch units includes one image sensor chip and one optical lens assembly.

8. The manufacturing process as defined in claim 7, wherein the array is made by making barrels by lithogrophy electroforming micro molding (LIGA) and assembling at least a lens onto each of the barrels.

9. The manufacturing process as defined in claim 7, wherein the array is made by making barrels by deep reactive ion etching (DRIE) and assembling at least a lens onto each of the barrels respectively.
